(19) United States
(12) Patent Application Publication
(10) Pub. No.: US 2021/0284163 A1
(43) Pub. Date: Sep. 16, 2021

(54) VEHICLE CONTROL APPARATUS, VEHICLE, VEHICLE CONTROL METHOD, AND STORAGE MEDIUM

(71) Applicant: HONDA MOTOR CO., LTD., Tokyo (JP)

(72) Inventors: Keisuke OKA, Wako-shi (JP); Shun IWASAKI, Wako-shi (JP)

(21) Appl. No.: 17/184,861

(22) Filed: Feb. 25, 2021

(30) Foreign Application Priority Data
Mar. 11, 2020 (JP) 2020-042053

(51) Int. Cl. B60W 30/18; B60W 30/16

(52) U.S. Cl. CPC B60W 30/18163; B60W 30/18159; B60W 30/16

(57) ABSTRACT

A vehicle control apparatus for controlling traveling of a vehicle comprises an acquisition unit configured to acquire information around the vehicle, and a control unit configured to control a lane change of the vehicle in accordance with a guidance route. If it is determined, based on the information acquired by the acquisition unit, that a bus stop exists near a point where the lane change is scheduled to be made, the control unit controls the vehicle to complete the lane change before the bus stop.

This application claims priority to and the benefit of Japanese Patent Application No. 2020-042053 filed on Mar. 11, 2020, the entire disclosure of which is incorporated herein by reference.

### BACKGROUND OF THE INVENTION

### Field of the Invention

The present invention relates to a vehicle control apparatus, a vehicle, a vehicle control method, and a storage medium.

### Description of the Related Art

Japanese Patent Laid-Open No. 2007-178358 discloses a route guide technique in which a bus lane kl is set to a recommended lane if the current time is not included in a regulation time zone, a lane k2 adjacent to the bus lane is set to a recommended lane if the current time is included in the regulation time zone, and in a section from a recommended lane change point p1 to a guide intersection c1, a lane change from the lane k2 is performed to use the bus lane k1 as the recommended lane.

However, if the technique of Japanese Patent Laid-Open No. 2007-17835 is applied to a road environment in which a bus stop exists near a point where a lane change is scheduled to be made, it is necessary not only to perform lane change control on the recommended lane but also to predict whether a bus stopped at the bus stop is going to start and determine whether to make a lane change on the front side of the bus or on the rear side of the bus, resulting in an increase in the processing load of vehicle control.

The present invention provides a vehicle control technique capable of reducing the processing load of vehicle control in a road environment in which a bus stop exists near a point where a lane change is scheduled to be made.

### SUMMARY OF THE INVENTION

According to one aspect of the present invention, there is provided a vehicle control apparatus for controlling traveling of a vehicle, comprising: an acquisition unit configured to acquire information around the vehicle; and a control unit configured to control a lane change of the vehicle in accordance with a guidance route, wherein if it is determined, based on the information acquired by the acquisition unit, that a bus stop exists near a point where the lane change is scheduled to be made, the control unit controls the vehicle to complete the lane change before the bus stop.

According to the present invention, it is possible to reduce the processing load of vehicle control by controlling a vehicle to complete a lane change before a bus stop if it is determined that the bus stop exists near a point where a lane change is scheduled to be made.

According to the present invention, without performing determination processing of a large processing load to predict whether a bus stopped at the bus stop is going to start and determine whether to make a lane change on the front side of the bus or on the rear side of the bus, traveling control of a vehicle can be performed by simple processing in a state in which a start after waiting for a short time is guaranteed.

### BRIEF DESCRIPTION OF THE DRAWINGS

FIG. 1 is a block diagram showing the basic arrangement of a vehicle control apparatus;

FIG. 2 is a control block diagram of the vehicle control apparatus;

FIG. 3 is a flowchart for explaining the procedure of processing of vehicle control (Control Example 1) according to the embodiment;

FIG. 4 is a view for schematically explaining vehicle control (Control Example 1) concerning a lane change;

FIG. 5 is a flowchart for explaining the procedure of processing of vehicle control (Control Example 2) according to the embodiment; and

FIG. 6 is a view for schematically explaining vehicle control (Control Example 2) concerning a lane change.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

(Arrangement of Vehicle Control Apparatus)

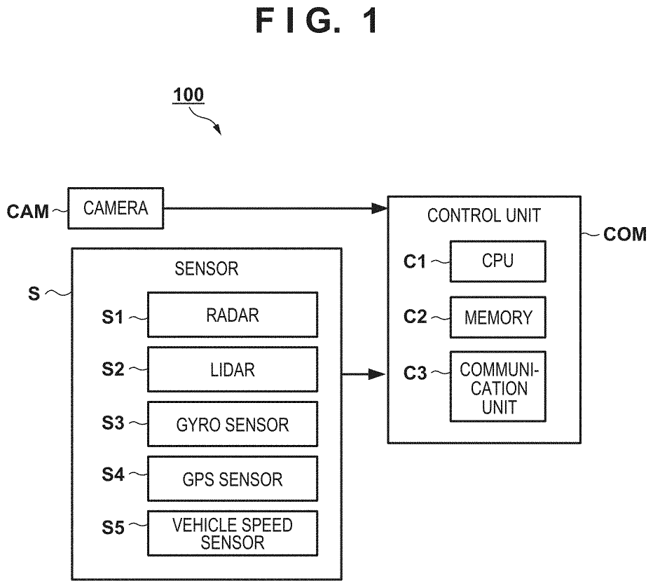

FIG. 1 is a block diagram showing the basic arrangement of a vehicle control apparatus that performs automated driving control of a vehicle. A vehicle control apparatus 100 includes a sensor S, a plurality of cameras CAM, and a computer COM. The sensor S includes, for example, a plurality of radars S1, a plurality of LiDARs S2 (Light Detection and Ranging), a gyro sensor S3, a GPS sensor S4, and a vehicle speed sensor S5. The sensor S and the camera CAM acquire the information of the vehicle and various kinds of information around the vehicle and input the acquired information to the control unit COM.

The control unit COM includes a CPU C1 that controls processing concerning automated driving control of the vehicle, a memory C2, a communication unit C3 capable of communicating with a server on a network or an external device, and the like. The control unit COM performs image processing for the information input from the sensor S (the radars S1 and the LiDARs S2) and the camera CAM, extracts a target (object) existing around the self-vehicle, analyzes what kind of target is arranged around the self-vehicle, and monitors the target.

Also, the gyro sensor S3 detects the rotational motion and the posture of the self-vehicle, and the control unit COM can determine the course of the self-vehicle based on the detection result of the gyro sensor S3 or a vehicle speed detected by the vehicle speed sensor S5. In addition, the control unit COM can detect the current position (position information) of the self-vehicle on map information and the positions of intersections and bus stops based on the detection result of the GPS sensor S4. The control unit COM can also perform image processing for the information input from the sensor S (the radars S1 and the LiDARs S2) and the camera CAM, and detect intersections and bus stops using the information of an extracted target (object). The control unit COM can perform automated driving control of the vehicle based on the information input from the sensor S and the camera CAM.

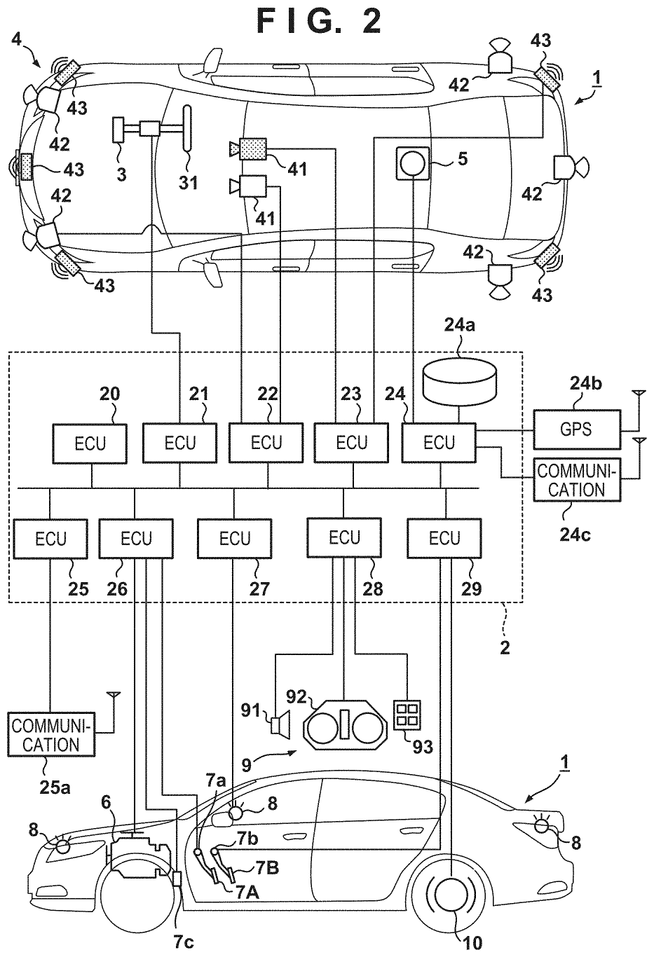

In a case in which the vehicle is to incorporate the vehicle control apparatus shown in FIG. 1, the control unit COM may be arranged in, for example, an ECU of a recognition processing system that processes information of the sensors S or the cameras CAM or an ECU of an image processing system, or may be arranged in an ECU for controlling a communication device and an input/output device. The control unit COM may be arranged in an ECU in a control unit that executes vehicle driving control, or an ECU for automated driving. For example, as shown in FIG. 2 to be described below, the function of the control unit COM may be distributed among a plurality of ECUs that form the vehicle control apparatus 100 such as the ECUs of the sensors S, the ECUs of the cameras, the ECU of the input/output device, the ECU for automated driving, and the like.

FIG. 2 is a control block diagram of the vehicle control apparatus 100 for controlling a vehicle 1. The outline of the vehicle 1 is shown by a plan view and a side view in FIG. 2. The vehicle 1 is, for example, a sedan-type four-wheeled vehicle.

A control unit 2 shown in FIG. 2 controls each unit of the vehicle 1. The control unit 2 includes a plurality of ECUs 20 to 29 communicably connected by an in-vehicle network. Each ECU (Electronic Control Unit) includes a processor represented by a CPU, a storage device such as a semiconductor memory, an interface with an external device, and the like. The storage device stores programs to be executed by the processor, data to be used by the processor for processing, and the like. Each ECU may include a plurality of processors, storage devices, and interfaces.

The functions and the like provided by the ECUs 20 to 29 will be described below. Note that the number of ECUs and the provided functions can be appropriately designed in the vehicle 1, and they can be subdivided or integrated as compared to this embodiment.

The ECU 20 executes control associated with automated driving of the vehicle 1 (self-vehicle) according to this embodiment. In automated driving, at least one of steering and acceleration/deceleration of the vehicle 1 is automatically controlled. Processing associated with more specific control related to automated driving will be described in detail later.

The ECU 20 executes control related to automated driving of the vehicle 1. In automated driving, steering, lane change, and acceleration/deceleration of the vehicle 1 are automatically controlled.

The ECU 21 controls an electric power steering device 3. The electric power steering device 3 includes a mechanism that steers front wheels in accordance with a driving operation (steering operation) of a driver on a steering wheel 31. In addition, the electric power steering device 3 includes a motor that generates a driving force to assist the steering operation or automatically steer the front wheels, and a sensor that detects the steering angle. If the driving state of the vehicle 1 is automated driving, the ECU 21 automatically controls the electric power steering device 3 in correspondence with an instruction from the ECU 20 and controls the direction of travel of the vehicle 1.

The ECUs 22 and 23 control detection units 41 to 43 that detect the peripheral state of the vehicle, and perform information processing of detection results. Detection units 41 are components corresponding to the cameras CAM of FIG. 1 and are image capturing devices (to be sometimes referred to as cameras 41 hereinafter) that perform image capturing to detect an object on the front side of the vehicle 1. In this embodiment, the cameras 41 are attached to the windshield inside the vehicle cabin at the front of the roof of the vehicle 1 to capture the front side of the vehicle 1. It is possible to extract the contour of a target located on the front side of the vehicle 1 or extract a division line (white line) of a lane on a road by analysis (image processing) of images captured by the cameras 41.

The detection unit 42 (LiDAR detection unit) is a Light Detection and Ranging (LiDAR) (to be sometimes referred to as the LiDAR 42 hereinafter), and uses light to detect a target around the vehicle 1 or measure the distance to a target. The detection units 42 (LiDARs 42) are components corresponding to the LiDARs S2 in FIG. 1. In this embodiment, five LiDARs 42 are provided; one at each corner of the front portion of the vehicle 1, one at the center of the rear portion, and one on each side of the rear portion.

The detection unit 43 (radar detection unit) is a millimeter wave radar (to be sometimes referred to as the radar 43 hereinafter), and uses radio waves to detect a target around the vehicle 1 or measure the distance to a target. The detection units 43 (radars 43) are components that correspond to radars S1 in FIG. 1. In this embodiment, five radars 43 are provided; one at the center of the front portion of the vehicle 1, one at each corner of the front portion, and one at each corner of the rear portion.

The ECU 22 controls one camera 41 and each LiDAR 42 and performs information processing of detection results. The ECU 23 controls the other camera 41 and each radar 43 and performs information processing of detection results. Since two sets of devices that detect the peripheral state of the vehicle are provided, the reliability of detection results can be improved. In addition, since detection units of different types such as cameras, LiDARs, and radars are provided, the peripheral environment of the vehicle can be analyzed multilaterally.

The ECU 24 performs control of a gyro sensor 5, a GPS sensor 24b, and a communication device 24c and information processing of detection results or communication results. The gyro sensor 5 detects a rotary motion of the vehicle 1. The course of the vehicle 1 can be determined based on the detection result of the gyro sensor 5, the wheel speed, or the like. The GPS sensor 24b detects the current position of the vehicle 1. The communication device 24c performs wireless communication with a server that provides map information and traffic information and obtains these pieces of information. The ECU 24 can access a map information database 24a formed in the storage device. The ECU 24 searches for a route from the current position to the destination. The database 24a can be arranged on a network, and the communication device 24c can obtain information by accessing the database 24a on the network. The gyro sensor 5, the GPS sensor 24b, and the communication device 24c are components that correspond to the gyro sensor S3, the GPS sensor S4, and the communication unit C3, respectively, in FIG. 1. The ECU 25 includes a communication device 25a for inter-vehicle communication. The communication device 25a performs wireless communication with another vehicle on the periphery and exchanges information between the vehicles.

The ECU 26 controls a power plant 6. The power plant 6 is a mechanism that outputs a driving force to rotate the driving wheels of the vehicle 1 and includes, for example, an engine and a transmission. The ECU 26, for example, controls the output of the engine in correspondence with a driving operation (accelerator operation or acceleration operation) of the driver detected by an operation detection sensor 7a provided on an accelerator pedal 7A, or switches the gear ratio of the transmission based on information such as a vehicle speed detected by a vehicle speed sensor 7c (the vehicle speed sensor S5 in FIG. 1). If the driving state of the vehicle 1 is automated driving, the ECU 26 automatically controls the power plant 6 in correspondence with an instruction from the ECU 20 and controls the acceleration/deceleration of the vehicle 1.

The ECU 27 controls lighting devices (headlights, taillights, and the like) including direction indicators 8 (turn signals). In the example shown in FIG. 1, the direction indicators 8 are provided in the front portion, door mirrors, and the rear portion of the vehicle 1.

The ECU 28 controls an input/output device 9. The input/output device 9 outputs information to the driver and accepts input of information from the driver. A voice output device 91 notifies the driver of information by voice. A display device 92 notifies the driver of information by displaying an image. The display device 92 is arranged, for example, in front of the driver's seat and constitutes an instrument panel or the like. Note that although notification by voice and display have been exemplified here, the driver may be notified of information using a vibration or light. Alternatively, the driver may be notified of information by a combination of some of the voice, display, vibration, and light. Furthermore, the combination or the notification mode may be changed in accordance with the level (for example, the degree of urgency) of information of which the driver is to be notified.

Although an input device 93 is a switch group that is used to issue an instruction to the vehicle 1 and arranged at a position where the driver can perform an operation, it may also include a voice input device.

The ECU 29 controls a brake device 10 and a parking brake (not shown). The brake device 10 is, for example, a disc brake device which is provided for each wheel of the vehicle 1 and decelerates or stops the vehicle 1 by applying a resistance to the rotation of the wheel. The ECU 29, for example, controls the operation of the brake device 10 in correspondence with a driving operation (brake operation) of the driver detected by an operation detection sensor 7b provided on a brake pedal 7B. If the driving state of the vehicle 1 is automated driving, the ECU 29 automatically controls the brake device 10 in correspondence with an instruction from the ECU 20 and controls deceleration and stop of the vehicle 1. The brake device 10 or the parking brake can also be operated to maintain the stop state of the vehicle 1. In addition, if the transmission of the power plant 6 includes a parking lock mechanism, it can be operated to maintain the stopped state of the vehicle 1.

<Control Example 1>

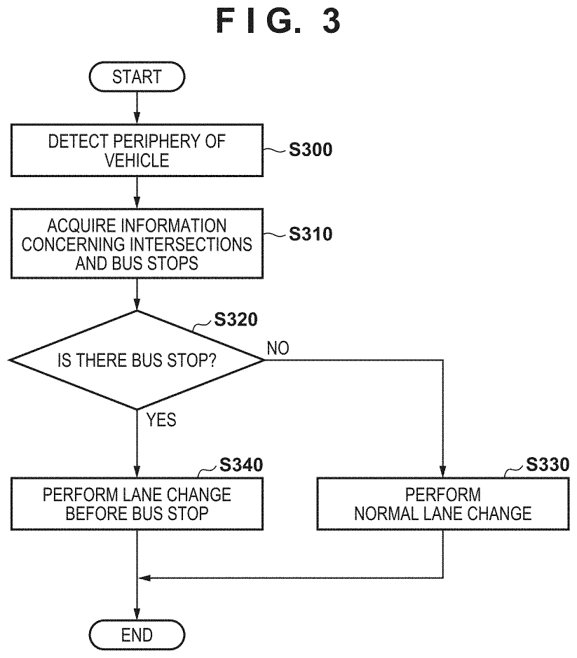

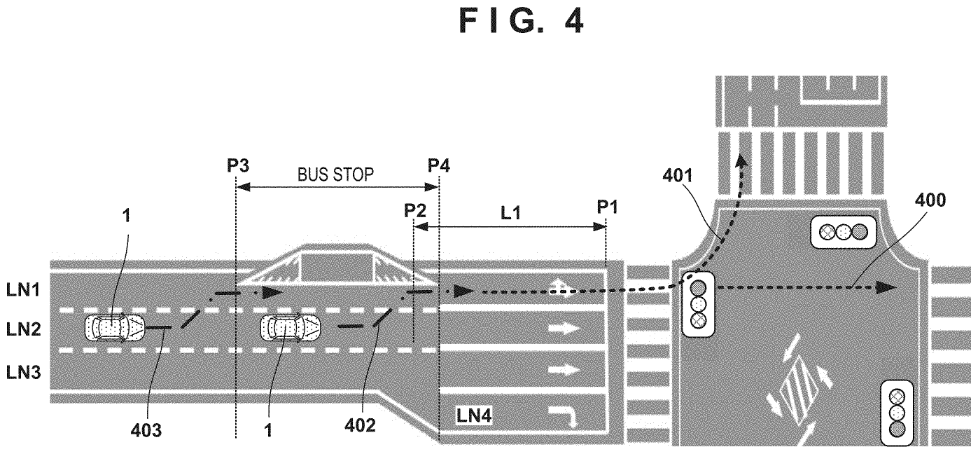

Control Example 1 of vehicle control of the vehicle 1 executed by the ECU 20 will be described. FIG. 3 is a flowchart for explaining the procedure of processing of Control Example 1 of vehicle control according to the embodiment. FIG. 4 is a view for schematically explaining vehicle control (Control Example 1) concerning a lane change executed by the ECU 20. When the driver instructs a destination and automated driving, the ECU 20 automatically controls traveling of the vehicle 1 to the destination in accordance with a guidance route searched by the ECU 24. At the time of automated driving, the ECU 20 acquires information concerning the peripheral state of the vehicle 1 from the ECUs 22 and 23, and instructs the ECUs 21, 26, and 29 based on the acquired information to control the steering, lane change, and acceleration/deceleration of the vehicle 1.

The ECU 22 controls one camera 41 and each LiDAR 42 and performs information processing of detection results. The ECU 23 controls the other camera 41 and each radar 43 and performs information processing of detection results. The ECU 20 executes control associated with automated driving of the vehicle 1.

In step S300, the cameras 41, the LiDARs 42, and the radars 43 detect the periphery of the vehicle.

In step S310, the ECU 22 and the ECU 23 function as an acquisition unit, and acquire information concerning the detection regions on the periphery of the vehicle 1. The ECUs 22 and 23 (acquisition unit) acquire information concerning intersections and bus stops as the information on the periphery of the vehicle 1. Acquisition of information concerning intersections and bus stops is not limited to this example, and the ECUs 22 and 23 (acquisition unit) can also acquire information concerning the current position (position information) of the vehicle 1 (self-vehicle) on map information or the positions of intersections and bus stops based on the detection result of the GPS sensor 24b.

In step S320, the ECU 20 that executes control associated with automated driving of the vehicle 1 functions as a control unit. The ECU 20 (control unit) determines, based on the information acquired by the ECU 22 and the ECU 23 (acquisition unit), whether a bus stop exists near a point where a lane change is scheduled to be made on the guidance route. If a bus stop does not exist near the point where a lane change is scheduled to be made (NO in step S320), in step S330, the ECU 20 (control unit) executes vehicle control to perform a normal lane change in accordance with the guidance route.

FIG. 4 shows a case in which the point where a lane change is scheduled to be made is an intersection. Referring to FIG. 4, traveling lanes are four lanes (LN1 to LN4), and the vehicle 1 is traveling on the second lane LN2 (straight lane) of these. As a guidance route 401, a route (a route from the lower side to the upper side on the drawing) that is directed from the straight route for traveling on the straight lane (a route from the left side to the right side on the drawing) and to the direction of turning left is set.

Referring to FIG. 4, if a bus stop does not exist, the ECU 20 (control unit) controls the vehicle 1 (self-vehicle) such that the lane change from the second lane LN2 (straight lane) to the first lane LN1 (straight and left turning lane) is completed until a position P2 apart from a position P1 of a stop line by a distance of L1 m. Here, the distance L1 is a distance defined by the law, and a route 402 indicates the vehicle route of the normal lane change to be executed by the ECU 20 (control unit).

On the other hand, if a bus stop exists near the point where a lane change is scheduled to be made on the guidance route (YES in step S320), in step S340, the ECU 20 (control unit) controls the vehicle such that the lane change from is completed before the bus stop. The ECU 20 (control unit) starts the lane change in step S340 at a timing earlier than the normal lane change (step S330).

The bus stop is a region located on a side of the first lane LN1 (straight and left turning lane) and provided between a start position P3 (the position of the first end portion) of the bus stop region and an end position P4 (the position of the second end portion) of the bus stop region. The ECU 20 (control unit) controls steering or acceleration/deceleration of the vehicle 1, and controls the vehicle such that the lane change from the second lane LN2 (straight lane) to the first lane LN1 (straight and left turning lane) is completed before the start position P3 of the bus stop region, that is, before the bus stop located near the point (for example, the position P2 in FIG. 4) where a lane change is scheduled to be made. A route 403 indicates the vehicle route of the lane change to be executed by the ECU 20 (control unit).

The lane change by the ECU 20 (control unit) is performed not only in a case in which the lane change is made at the position P2 in FIG. 4 to straightly travel on the first lane LN1 detection in accordance with a guidance route 400 but also in a case in which a lane change to a lane for a right/left turn is made to make a right/left turn without crossing the opposite lane at the intersection in accordance with the guidance route 401.

When making a right/left turn without crossing the opposite lane at the intersection, the ECU 20 (control unit) controls the vehicle 1 to make a lane change to a lane for making a right/left turn. If it is determined that a bus stop exists before the intersection where a right/left turn is to be made without crossing the opposite lane, the vehicle 1 is controlled such that the lane change is completed before the bus stop. That is, the ECU 20 (control unit) controls the vehicle such that the lane change from the second lane LN2 (straight lane) to the first lane LN1 (straight and left turning lane) is completed before the start position P3 of the bus stop region.

In the lane change control of step S340, the ECU 20 (control unit) controls the vehicle 1 to complete the lane change before the bus stop independently of whether a bus is stopped at the bus stop (P3 to P4).

If a bus is not stopped at the bus stop, the ECU 20 (control unit) continues traveling of the vehicle 1 after completion of the lane change and, for example, controls the traveling of the vehicle 1 in accordance with the guidance route 401 or 402.

If a bus is stopped at the bus stop, the ECU 20 (control unit) determines, based on the information acquired by the ECUs 22 and 23 (acquisition unit), that the vehicle stopped at the bus stop is a bus, and controls the vehicle 1 such that it makes a stop (wait stop) behind the bus after completion of the lane change. Then, the ECU 20 (control unit) controls the vehicle 1 to start traveling following the start of the bus. The ECU 20 cancels the wait control state following the start of the bus, starts traveling control of the vehicle 1, and, for example, controls the traveling of the vehicle 1 in accordance with the guidance route 401 or 402.

In Control Example 1, a bus that is stopped can be predicted to start after completion of getting on/off. For this reason, if a bus is stopped at the bus stop, the vehicle 1 is controlled such that it makes a stop (wait stop) behind the bus after completion of the lane change. According to the processing of Control Example 1, without performing determination processing of a large processing load to predict whether the bus stopped at the bus stop is going to start and determine whether to make a lane change on the front side of the bus or on the rear side of the bus, traveling control of the vehicle 1 can be performed by simple processing in a state in which a start after waiting for a short time is guaranteed.

<Control Example 2>

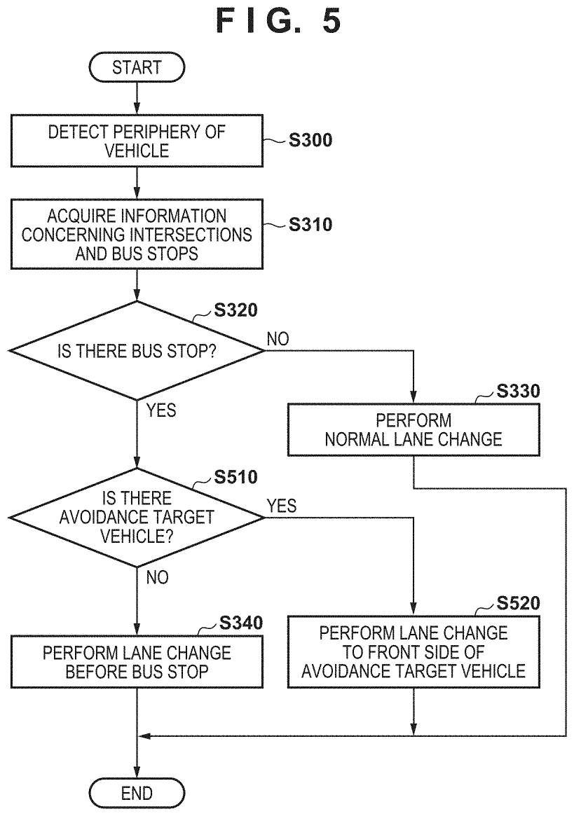

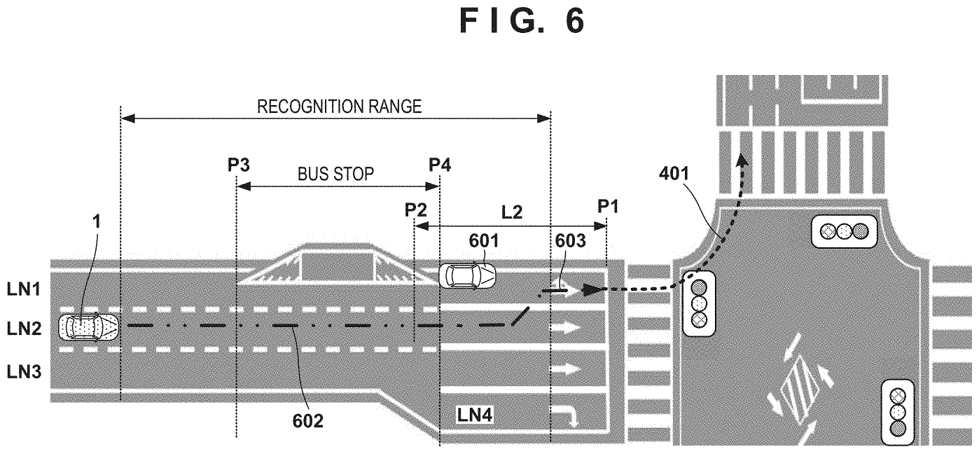

Control Example 2 of vehicle control of the vehicle 1 executed by the ECU 20 will be described. FIG. 5 is a flowchart for explaining the procedure of processing of Control Example 2 of vehicle control according to the embodiment. FIG. 6 is a view for schematically explaining vehicle control (Control Example 2) concerning a lane change executed by the ECU 20. Referring to FIG. 5, the processes of steps S300 to S340 are the same as the processes described with reference to FIG. 3. Control Example 2 is different from Control Example 1 in that the processes of steps S510 and S520 are added.

In step S510, the ECU 20 (control unit) determines, based on the information acquired by the ECUs 22 and 23 (acquisition unit) from the recognition range on the front side, whether an avoidance target vehicle (another vehicle) other than a bus is stopped at a position (lane side area) other than the bus stop (P3 to P4). The ECU 20 (control unit) can specifically determine the type of the other vehicle based on the information acquired by the ECUs 22 and 23 (acquisition unit). In addition, based on the association with the bus stop, the ECU 20 can determine that a vehicle stopped at the bus stop is a bus and determine that a vehicle stopped at a position other than the bus stop is an avoidance target vehicle (another vehicle) other than a bus. When the determination processing is performed based on the association with the bus stop, it is possible to determine whether a vehicle is a bus or an avoidance target vehicle (another vehicle) other than a vehicle while reducing the calculation load.

If another vehicle 601 other than a bus is stopped at a position other than the bus stop region in the determination of step S510 (YES in step S510), in step S520, the ECU 20 (control unit) controls the vehicle 1 to make a lane change after the vehicle 1 (self-vehicle) is made to travel up to the front side of the avoidance target vehicle (other vehicle 601). In Control Example 2, if an avoidance target vehicle (another vehicle) other than a bus is stopped at a position other than the bus stop, instead of performing lane change control such that the lane change is completed before the bus stop, as in Control Example 1, the ECU 20 (control unit) controls the vehicle 1 (self-vehicle) traveling on the second lane LN2 in accordance with a route 602, as shown in FIG. 6. After the vehicle 1 (self-vehicle) travels up to the front side of the avoidance target vehicle (other vehicle 601), the ECU 20 (control unit) controls the vehicle 1 in accordance with a route 603 to make a lane change from the second lane LN2 (straight lane) to the first lane LN1 (straight and left turning lane). The route 603 indicates the vehicle route of the lane change to be executed by the ECU 20 (control unit). When the lane change is made after traveling up to the front side of the avoidance target vehicle (other vehicle 601), lane change control can be performed in a state in which the vehicle interval between the other vehicle 601 and the vehicle 1 (self-vehicle) is ensured.

The avoidance target vehicle (other vehicle 601) other than a bus cannot be predicted to start after completion of getting on/off, like a bus. Hence, if the vehicle makes a stop (wait stop) behind the avoidance target vehicle (other vehicle 601), the timing of the next start is uncertain. For this reason, in the processing of Control Example 2, the vehicle 1 is controlled to make a lane change after the vehicle 1 (self-vehicle) travels up to the front side of the avoidance target vehicle (other vehicle 601). According to the processing of Control Example 2, traveling control of the vehicle 1 can be performed by simple processing while reducing the processing load required for determination processing of predicting whether a bus is going to start and avoiding a state in which the timing of start becomes uncertain.

<Summary of Embodiment>

The above-described embodiment discloses at least the following vehicle control apparatus, a vehicle including the vehicle control apparatus, a vehicle control method of the vehicle control apparatus, and a storage medium that stores a program.

Arrangement 1. A vehicle control apparatus according to the above-described embodiment is a vehicle control apparatus (for example, 100 in FIG. 1) for controlling traveling of a vehicle (for example, 1 in FIG. 2), comprising:

an acquisition unit (for example, 22, 23 in FIG. 2) configured to acquire information around the vehicle; and

a control unit (for example, 20 in FIG. 2) configured to control a lane change of the vehicle in accordance with a guidance route,

wherein if it is determined, based on the information acquired by the acquisition unit (22, 23), that a bus stop (for example, P3-P4 in FIG. 4) exists near a point where the lane change is scheduled to be made, the control unit vehicle (1) to complete the lane change before the bus stop (for example, P3).

According to the vehicle control apparatus of Arrangement 1, if it is determined that a bus stop exists near the point where the lane change is scheduled to be made, the vehicle is controlled to complete the lane change before the bus stop, thereby reducing the processing load of vehicle control. That is, without performing determination processing of a large processing load to predict whether a bus stopped at the bus stop is going to start and determine whether to make a lane change on the front side of the bus or on the rear side of the bus, traveling control of the vehicle can be performed by simple processing in a state in which a start after waiting for a short time is guaranteed.

Arrangement 2. In the vehicle control apparatus (100) according to the above-described embodiment, the control unit (20) controls the vehicle (1) to complete the lane change before the bus stop independently of whether a bus is stopped at the bus stop.

According to the vehicle control apparatus of Arrangement 2, without performing determination processing of a large processing load to predict whether a bus stopped at the bus stop is going to start and determine whether to make a lane change on the front side of the bus or on the rear side of the bus, traveling control of the vehicle can be performed by simple processing.

Arrangement 3. In the vehicle control apparatus (100) according to the above-described embodiment, the control unit (20) determines, based on the information acquired by the acquisition unit (22, 23), that a vehicle stopped at a position other than the bus stop is another vehicle (for example, 601 in FIG. 6) other than a bus, and controls the vehicle (1) to make the lane change after the vehicle travels up to a front side of the other vehicle.

According to the vehicle control apparatus of Arrangement 3, traveling control of the vehicle can be performed by simple processing while reducing the processing load required for determination processing of predicting whether a bus is going to start and avoiding a state in which the timing of start becomes uncertain.

Arrangement 4. In the vehicle control apparatus (100) according to the above-described embodiment, the control unit (20) determines, based on the information acquired by the acquisition unit (22, 23), that a vehicle stopped at the bus stop is a bus, and controls the vehicle (1) to stop behind the bus after completion of the lane change.

Arrangement 5. In the vehicle control apparatus (100) according to the above-described embodiment, the control unit (20) controls the vehicle (1) to start traveling following a start of the bus.

According to the vehicle control apparatus of Arrangements 4 and 5, without performing determination processing of a large processing load to predict whether a bus stopped at the bus stop is going to start and determine whether to make a lane change on the front side of the bus or on the rear side of the bus, traveling control of the vehicle can be performed by simple processing in a state in which a start after waiting for a short time is guaranteed.

Arrangement 6. In the vehicle control apparatus (100) according to the above-described embodiment, when making a right/left turn without crossing an opposite lane at an intersection on the guidance route, the control unit (20) controls the vehicle (1) to make the lane change to a lane for making the right/left turn.

Arrangement 7. In the vehicle control apparatus (100) according to the above-described embodiment, if it is determined that the bus stop exists before the intersection where the right/left turn is made without crossing the opposite lane, the control unit (20) controls the vehicle (1) to complete the lane change before the bus stop.

According to the vehicle control apparatus of Arrangements 6 and 7, if it is determined that a bus stop exists near the point where the lane change is scheduled to be made, the vehicle is controlled to complete the lane change before the bus stop, thereby reducing the processing load of vehicle control. That is, without performing determination processing of a large processing load to predict whether a bus stopped at the bus stop is going to start and determine whether to make a lane change on the front side of the bus or on the rear side of the bus, traveling control of the vehicle can be performed by simple processing in a state in which a start after waiting for a short time is guaranteed.

Arrangement 8. A vehicle according to the above-described embodiment is a vehicle 1 (for example, 1 in FIG. 2) including a vehicle control apparatus (for example, 100 in FIG. 1) configured to control traveling of a vehicle,

wherein the vehicle control apparatus (100) comprises:

an acquisition unit (for example, 22, 23 in FIG. 2) configured to acquire information around the vehicle; and

a control unit (for example, 20 in FIG. 2) configured to control a lane change of the vehicle in accordance with a guidance route,

wherein if it is determined, based on the information acquired by the acquisition unit (22, 23), that a bus stop (for example, P3-P4 in FIG. 4) exists near a point where the lane change is scheduled to be made, the control unit 20) vehicle (1) to complete the lane change before the bus stop (for example, P3).

According to the vehicle of Arrangement 8, it is possible to provide a vehicle including a vehicle control apparatus capable of, if it is determined that a bus stop exists near the point where the lane change is scheduled to be made, controlling the vehicle to complete the lane change before the bus stop, thereby reducing the processing load of vehicle control. That is, it is possible to provide a vehicle including a vehicle control apparatus capable of, without performing determination processing of a large processing load to predict whether a bus stopped at the bus stop is going to start and determine whether to make a lane change on the front side of the bus or on the rear side of the bus, performing traveling control of the vehicle by simple processing in a state in which a start after waiting for a short time is guaranteed.

Arrangement 9. A vehicle control method according to the above-described embodiment is a vehicle control method of a vehicle control apparatus (for example, 100 in FIG. 1) for controlling traveling of a vehicle, comprising:

an acquisition step (for example, S300, S310 in FIG. 3) of acquiring information around the vehicle; and

a control step (for example, S320-S340 in FIG. 3) of controlling a lane change of the vehicle in accordance with a guidance route,

wherein in the control step (S340),

if it is determined, based on the information acquired in the acquisition step, that a bus stop exists near a point where the lane change is scheduled to be made, vehicle is controlled to complete the lane change before the bus stop.

Arrangement 10. A storage medium that stores a program according to the above-described embodiment is a storage medium that stores a program configured to cause a computer to execute each step of a vehicle control method of a vehicle control apparatus (for example, 100 in FIG. 1) for controlling traveling of a vehicle, the vehicle control method comprising:

an acquisition step (for example, S300, S310 in FIG. 3) of acquiring information around the vehicle; and

a control step (for example, S320-S340 in FIG. 3) of controlling a lane change of the vehicle in accordance with a guidance route,

wherein in the control step (S340),

if it is determined, based on the information acquired in the acquisition step, that a bus stop exists near a point where the lane change is scheduled to be made, vehicle is controlled to complete the lane change before the bus stop.

According to the vehicle control method of Arrangement 9 and the storage medium that stores the program of Arrangement 10, if it is determined that a bus stop exists near the point where the lane change is scheduled to be made, the vehicle is controlled to complete the lane change before the bus stop, thereby reducing the processing load of vehicle control. In addition, without performing determination processing of a large processing load to predict whether a bus stopped at the bus stop is going to start and determine whether to make a lane change on the front side of the bus or on the rear side of the bus, traveling control of the vehicle can be performed by simple processing in a state in which a start after waiting for a short time is guaranteed.

(Other Embodiments)

The present invention can also be implemented by supplying a program that implements the functions of the above-described embodiment to a system or an apparatus via a network or a storage medium, and one or more processors in the computer of the system or apparatus read out and execute the program.

The invention is not limited to the foregoing embodiments, and various variations/changes are possible within the spirit of the invention.

What is claimed is:

1. A vehicle control apparatus for controlling traveling of a vehicle, comprising:
an acquisition unit configured to acquire information around the vehicle; and
a control unit configured to control a lane change of the vehicle in accordance with a guidance route,
wherein if it is determined, based on the information acquired by the acquisition unit, that a bus stop exists near a point where the lane change is scheduled to be made, the control unit controls the vehicle to complete the lane change before the bus stop.

2. The apparatus according to claim 1, wherein the control unit controls the vehicle to complete the lane change before the bus stop independently of whether a bus is stopped at the bus stop.

3. The apparatus according to claim 1, wherein the control unit determines, based on the information acquired by the acquisition unit, that a vehicle stopped at a position other than the bus stop is another vehicle other than a bus, and controls the vehicle to make the lane change after the vehicle travels up to a front side of the other vehicle.

4. The apparatus according to claim 1, wherein the control unit determines, based on the information acquired by the acquisition unit, that a vehicle stopped at the bus stop is a bus, and
controls the vehicle to stop behind the bus after completion of the lane change.

5. The apparatus according to claim 4, wherein the control unit controls the vehicle to start traveling following a start of the bus.

6. The apparatus according to claim 1, wherein when making a right/left turn without crossing an opposite lane at an intersection on the guidance route, the control unit controls the vehicle to make the lane change to a lane for making the right/left turn.

7. The apparatus according to claim 6, wherein if it is determined that the bus stop exists before the intersection where the right/left turn is made without crossing the opposite lane, the control unit controls the vehicle to complete the lane change before the bus stop.

8. A vehicle including a vehicle control apparatus configured to control traveling of a vehicle,
wherein the vehicle control apparatus comprises:
an acquisition unit configured to acquire information around the vehicle; and
a control unit configured to control a lane change of the vehicle in accordance with a guidance route,
wherein if it is determined, based on the information acquired by the acquisition unit, that a bus stop exists near a point where the lane change is scheduled to be made, the control unit controls the vehicle to complete the lane change before the bus stop.

9. A vehicle control method of a vehicle control apparatus for controlling traveling of a vehicle, comprising:
an acquisition step of acquiring information around the vehicle; and
a control step of controlling a lane change of the vehicle in accordance with a guidance route,
wherein in the control step,
if it is determined, based on the information acquired in the acquisition step, that a bus stop exists near a point where the lane change is scheduled to be made, the vehicle is controlled to complete the lane change before the bus stop.

10. A storage medium that stores a program configured to cause a computer to execute each step of a vehicle control method of a vehicle control apparatus for controlling traveling of a vehicle, the vehicle control method comprising:
an acquisition step of acquiring information around the vehicle; and
a control step of controlling a lane change of the vehicle in accordance with a guidance route,
wherein in the control step,
if it is determined, based on the information acquired in the acquisition step, that a bus stop exists near a point where the lane change is scheduled to be made, the vehicle is controlled to complete the lane change before the bus stop.
